(19) United States
(12) Patent Application Publication
(10) Pub. No.: US 2014/0199611 A1
(43) Pub. Date: Jul. 17, 2014

(54) PROTON-CONDUCTING MEMBRANE, METHOD FOR THEIR PRODUCTION AND THEIR USE IN ELECTROCHEMICAL CELLS

(71) Applicant: BASF SE, Ludwigshafen (DE)

(72) Inventors: Brian Benicewicz, Loudonville, NY (US); Guoqing Qian, Irmo, SC (US); Max Molleo, Columbia, SC (US); Harry Joseph Pleohn, Columbia, SC (US); Xiaoming Chen, West Columbia, SC (US); Jörg Belack, Skillman, NJ (US); Gordon Calundann, Somerset, NJ (US)

(73) Assignee: BASF SE, Ludwigshafen (DE)

(21) Appl. No.: 13/769,420

(22) Filed: Feb. 18, 2013

(30) Foreign Application Priority Data
Jan. 16, 2013 (IB) PCT/IB2013/000051

(51) Int. Cl. H01M 8/10

(52) U.S. Cl. CPC H01M 8/1027; H01M 8/103; H01M 8/102; H01M 8/1067
USPC 429/482; 429/492; 429/493

(57) ABSTRACT

The present invention relates to a novel proton-conducting polymer membrane based on polyazole polymers which, owing to their outstanding chemical and thermal properties, can be used widely and are suitable in particular as polymer electrolyte membrane (PEM) for producing membrane electrode assemblies or so-called PEM fuel cells.

The present invention relates to a novel proton-conducting polymer membrane based on polyazole polymers which, owing to their outstanding chemical and thermal properties, can be used widely and are suitable in particular as polymer electrolyte membrane (PEM) in so-called PEM fuel cells.

Polyazoles, for example polybenzimidazoles (Celazole®) have been known for some time. Such polybenzimidazoles (PBIs) are prepared typically by reacting 3,3″,4,4″-tetraaminobiphenyl with isophthalic acid or diphenylisophthalic acid or their esters thereof in the melt. The prepolymer formed solidifies in the reactor and is subsequently comminuted mechanically. Subsequently, the pulverulent prepolymer is finally polymerized in a solid-phase polymerization at temperatures of up to 400° C. and the desired polybenzimidazoles are obtained.

To prepare polymer films, the PBI, in a further step, is dissolved in suitable solvent, such as polar, aprotic solvents, for example by dimethylacetamide (DMAc), and a film is obtained by means of classical processes.

Proton-conducting, i.e. acid-doped, polyazole membranes for use in PEM fuel cells are already known. The basic polyazole films are doped with concentrated phosphoric acid or sulfuric acid and then act as proton conductors and separators in so-called polymer electrolyte membrane fuel cells (PEM fuel cells).

As a result of the outstanding properties of the polyazole polymers, such polymer electrolyte membranes, processed to give membrane-electrode assemblies (MEA), can be used in fuel cells at long-term operating temperatures above 100° C., in particular above 120° C. This high long-term operating temperature allows it to increase the activity of the noble metal-based catalysts present in the membrane-electrode assembly (MEA). Especially in the case of use of so-called reformates made from hydrocarbons, the reformer gas comprises significant amounts of carbon monoxide which typically have to be removed by a complicated gas workup or gas purification. The possibility of increasing the operating temperature allows distinctly higher concentrations of CO impurities to be tolerated on a long-term basis.

Use of polymer electrolyte membranes based on polyazole polymers firstly allows complicated gas workup or gas purification to be partly dispensed with and secondly allows the catalyst loading in the membrane-electrode assembly to be reduced. Both are unavoidable prerequisites for large-scale use of PEM fuel cells, since the costs for a PEM fuel cell system are otherwise too high.

The acid-doped polyazole-based polymer membranes known to date already exhibit a favorable property profile. However, owing to the applications desired for PEM fuel cells, especially in the automobile sector and decentralized power and heat generation (stationary sector), they are in need of improvement overall. Furthermore, the polymer membranes known to date have a high content of dimethylacetamide (DMAc) which cannot fully be removed by means of known drying methods. The International patent application WO 02/071518 describes a polymer membrane based on polyazoles in which the DMAc contamination has been eliminated. Although such polymer membranes exhibit improved mechanical properties, specific conductivities do not exceed 0.1 S/cm (at 140° C.) and solid content of the membranes is typically more than 30% by weight polymer.

U.S. Patent Application 2004/0096734 describes a novel, second generation, polymer membrane based on polyazoles which is obtained starting from the monomers by polymerizing in polyphosphoric acid. In PEM fuel cells, especially in high-temperature PEM fuel cells, this membrane exhibits outstanding performance. Typically, these second generation polymer membrane have a solid content of not more than 12% by weight polymer and polyphosphoric polymerization solutions having a general monomer content of more than 3% cannot be handled anymore so that film forming is rather difficult.

However, it has been found that these second generation polymer membrane are still in need of improvement with regard to their ability to resist deformation under mechanical stress, such as creep resulting from to compressive stress, and to ensure use under extreme conditions. Especially, the robustness of the polymer membrane in a built-in MEA/fuel cell stack needs to further improved.

For certain applications, such as the automobile sector and residential appliances, a PEM fuel cell has to be able to withstand many start-stop cycles without problem, even after being at rest at extremely low external temperatures.

In addition to these requirements, a higher mechanical durability of the membrane is also advantageous in the production of the membrane-electrode assembly and fuel cell stacks. For instance, considerable forces act on the membrane in the lamination, so that good stretchability and resilience can be advantageous. Further forces are compression forces when assembling the fuel cell stack in which each of the laminated membrane-electrode assemblies is further compressed. Under certain conditions, it has been found that the existing polymer membrane based on polyazoles can have a tendency to creep and to fluidify during operation and thus causing lifetime problems.

It is an object of the present invention to provide acid-containing polymer membranes based on polyazoles, which (i) have the performance advantages of the polymer membrane based on polyazoles, (ii) have at least the specific conductivity, especially at operating temperatures above 100° C. and additionally do not need moistening of the fuel gas, of the polymer membrane based on polyazoles, (iii) have better mechanical strength in terms of resistance to fluidification and creep, (iv) have sufficient mechanical strength in terms of higher elastic-modulus and (v) can be manufactured with existing equipment and established processes.

In order to achieve such object, the membranes to be accomplished should have the following set of parameters:
(a) the proton conductivity of the membrane without humidification should be at least 100 mS/cm, preferably at least 110 mS/cm, at 160° C., preferably 180° C.,
(b) the Young's Modulus of the membrane should be at least 5 MPa
(c) the compliance J(20h) of the membrane should not more than 6 MPa⁻¹ at 180° C., preferably not more than 5 MPa⁻¹ at 180° C., most preferred not more than 4 MPa⁻¹ at 180° C.

We have now found that a proton-conducting membrane based on polyazole polymers providing the above mentioned properties can be obtained when the polyazole polymer is a specific polymer/copolymer made from specific monomers using the polyphosphoric acid polycondensation process and subsequent sol-gel transfer.

The present invention provides a proton-conducting polymer membrane based on polyazole-polymers having
(a) a proton conductivity of the membrane without humidification should be at least 100 mS/cm, preferably at least 110 mS/cm, measured at 160° C., preferably 180° C.,
(b) the Young's Modulus of the membrane should be at least 5 MPa
(c) the compliance J(20h) of the membrane should not more than 6 MPa⁻¹ at 180° C., preferably not more than 5 MPa⁻¹ at 180° C., most preferred not more than 4 MPa⁻¹ at 180° C.
   obtainable by a process comprising the steps of
A) mixing:
   (i) at least one aromatic tetraamino compounds and
   (ii) at least two different aromatic carboxylic acids or esters thereof which contain at least two acid groups per carboxylic acid monomer
   or
   (iii) at least one aromatic tetraamino compounds and
   (iv) one aromatic carboxylic acids or esters thereof which contain at least two acid groups per carboxylic acid monomer, in polyphosphoric acid to form a solution and/or dispersion
B) heating the mixture from step A), preferably under inert gas, and polymerizing until an inherent viscosity of at least 0.8 dl/g, preferably at least 1.0 dl/g, in particular at least 1.5 dl/g, is obtained for the copolymer being formed,
C) applying a membrane layer using the mixture according to step B) on a carrier or on an electrode,
D) optionally heating the membrane on the carrier or electrode obtained from step C),
E) treating the membrane formed in the presence of water and/or moisture,
F) removal of the membrane from the carrier, characterized in that
G) one of the at least two different aromatic carboxylic acids or esters thereof which contain at least two acid groups per carboxylic acid monomer (first aromatic carboxylic acid) is pyridine-2,5-dicarboxylic acid or pyridine-3,5-dicarboxylic acid, and
H) one of the at least two different aromatic carboxylic acids or esters thereof which contain at least two acid groups per carboxylic acid monomer (second aromatic carboxylic acid) is selected from terephthalic acid, isophthalic acid, di-hydroxy-benzene-1,4-dicarboxylic acid, di-hydroxy-benzene-1,3-dicarboxylic acid, or di-hydroxy-benzene-1,2-dicarboxylic acid,
   OR
I) one of the at least two different aromatic carboxylic acids or esters thereof which contain at least two acid groups per carboxylic acid monomer (first aromatic carboxylic acid) is terephthalic acid and
J) one of the at least two different aromatic carboxylic acids or esters thereof which contain at least two acid groups per carboxylic acid monomer (second aromatic carboxylic acid) isophthalic acid,
   OR
   said one aromatic carboxylic acids monomer being isophthalic acid or an esters thereof,
K) the molar fraction of said first aromatic carboxylic acid is between 0.1 to 0.9, preferably 0.1 to 0.5, and
L) the molar fraction of said second aromatic carboxylic acid is chosen so that the sum of the molar fraction of the first aromatic carboxylic acid and the molar fraction of the second aromatic carboxylic acid is 1.0,
M) the total amount of all aromatic tetraamino compounds and all aromatic carboxylic acids or esters thereof in step A) is chosen so that the total amount of the copolymers being present is at least 17.5% by weight, preferably 20% by weight, more preferred at least 25% by weight, and said total amount includes any acids, such as polyphosphoric acid and/or phosphoric acid and water being present, said total content excluding however any optional additives.

### Step A):

The tetraamino compounds used in accordance with the invention are aromatic or heteroaromatic, preferred tetraamino compounds are 2,3,5,6-tetraaminopyridine, 3,3′,4,4′-tetraaminodiphenylsulfone, 3,3′,4,4′-tetraaminodiphenyl ether, 3,3′,4,4′-tetraaminobiphenyl, 1,2,4,5-tetraaminobenzene, 3,3′,4,4′-tetraaminobenzophenone, 3,3′,4,4′-tetraaminodiphenylmethane and 3,3′,4,4′-tetraaminodiphenyldimethyl-methane and the salts of the aforementioned compounds, especially the mono-, di-, tri- and tetrahydrochloride salts.

The aromatic carboxylic acids used in accordance with the invention are either alone or in combination with tricarboxylic acids and/or tetracarboxylic acids.

In addition the aromatic carboxylic acids used in accordance with the invention include their esters derivatives, especially the C1-C20-alkyl esters or C5-C12-aryl esters.

The aromatic carboxylic acids used in accordance with the invention for copolymers are
pyridine-2,5-dicarboxylic acid or
pyridine-3,5-dicarboxylic acid,
   and
2,3-dihydroxyterephthalic acid and/or
2,5-dihydroxyterephthalic acid and/or
2,6-dihydroxyterephthalic acid and/or
2,4-dihydroxyisophthalic acid and/or
2,5-dihydroxyisophthalic acid and/or
2,6-dihydroxyisophthalic acid and/or
4,5-dihydroxyisophthalic acid and/or
4,6-dihydroxyisophthalic acid and/or
3,4-dihydroxyphthalic acid and/or
3,5-dihydroxyphthalic acid and/or
3,6-dihydroxyphthalic acid and/or
4,5-dihydroxyphthalic acid and/or
4,6-dihydroxyphthalic acid and/or
2-mono-hydroxyterephthalic acid and/or
2-mono-hydroxyisophthalic acid and/or
4-mono-hydroxyisophthalic acid and/or
5-mono-hydroxyisophthalic acid and/or
3-mono-hydroxyphthalic acid and/or
4-mono-hydroxyphthalic acid and/or
5-mono-hydroxyphthalic acid and/or
6-mono-hydroxyphthalic acid and/or
isophthalic acid and/or
terephthalic acid.

In the aforementioned aromatic carboxylic acids one or more hydrogen atoms can be replaced by fluorine atoms and/or C1 to C4 alkyl groups.

The aromatic tricarboxylic acids or their C1-C20-alkyl ester or their C5-C12-aryl ester, or the acid anhydrides of said tricarboxylic acids, or the acid chlorides of said tricarboxylic acids, are preferably 1,3,5-benzenetricarboxylic acid (trimesic acid); 1,2,4-benzenetricarboxylic acid (trimellitic acid); (2-carboxyphenyl)iminodiacetic acid, 3,5,3′-biphenyltricarboxylic acid; 3,5,4′-biphenyltricarboxylic acid.

The aromatic tetracarboxylic acids or their C1-C20-alkyl ester or their C5-C12-aryl ester, or the acid anhydrides of said tetracarboxylic acids, or the acid chlorides of said tetracarboxylic acids, are preferably 3,5,3′,5′-biphenyltetracarboxylic acid; benzene-1,2,4,5-tetracarboxylic acid; benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid, 1,4,5,8-naphthalenetetracarboxylic acid.

The content of tricarboxylic acid or tetracarboxylic acids (based on dicarboxylic acid used) is between 0 and 10 mol %, preferably 0.1 and 10 mol %, in particular 0.5 and 5 mol %.

In step A) mixtures of at least 2 different aromatic carboxylic acids are prepared in which the molar fraction of the first aromatic carboxylic acid is between 0.1 to 0.9, preferably 0.1 to 0.5, the molar fraction of the second aromatic carboxylic acid is chosen so that the sum of the molar fraction of the first aromatic carboxylic acid and the molar fraction of the second aromatic carboxylic acid is 1.0. Thus the copolymers according to the current invention are random copolymers.

In addition, the total amount of all aromatic tetraamino compounds and all aromatic carboxylic acids or esters thereof in step A) is chosen so that the total amount of the copolymers being present is at least 17.5% by weight, preferably at least 20% by weight, more preferred least 25% by weight, and said total amount includes any acids, such as polyphosphoric acid and/or phosphoric acid and water being present, said total content excluding however any optional additives.

Typically, such objective is achieved by preparing the underlying monomer solutions in polyphosphoric acid in which the monomer are present by at least 5% by weight, preferably at least 10% by weight, most preferred at least 12% by weight, and up to about 25% by weight, preferably up to 20% by weight, and said total monomer content includes any acids, such as polyphosphoric acid and/or phosphoric acid and water being present, said total content excluding however any optional additives.

Usually, the amount of monomers is based on the free acids, so that in case derivatives of the acids, for example esters, are used as monomers, such amounts need to be adapted accordingly as the free acids would have been used.

The polyphosphoric acid used in step A) is commercial polyphosphoric acid as obtainable, for example, from Riedel-de Haen. The term “polyphosphoric acid” refers to concentrated grades of phosphoric acid (H₃PO₄) above 100%, preferably at least 110%. The upper limit for the term “polyphosphoric acid” refers to concentrated grades of phosphoric acid (H₃PO₄) not more than 120%.

At these high concentrations, the individual H₃PO₄ units are polymerized by dehydration and the polyphosphoric acids can be expressed by the formula Hₙ₊₂PₙO₃ₙ₊₁ (n>1).

### Step B)

The polymerization in steps B) is carried out at a temperature and for a time until an inherent viscosity of at least 0.8 dl/g, preferably at least 1.0 dl/g, in particular at least 1.5 dl/g, is obtained for the polyazole polymer to be formed. Typically, the temperatures are up to 220° C., preferably up to 200° C., in particular from 100° C. to 195° C. The time is typically from a few minutes (5 minutes) up to several hours (100 hours). Preferably, the heating is done stepwise, in particular in at least three steps, each step lasting from 10 minutes to 5 hours and increasing the temperature by at least 15° C. for each step. However, a skilled polymer expert knows that the above conditions depend upon the reactivity and concentration of the particular monomers.

### Step C)

The membrane formation according to step C) is effected by means of measures known per se (casting, spraying, knife-coating), which are known from the prior art for polymer film production. Suitable carriers are all carriers which can be referred to as inert under the conditions. To adjust the viscosity, the solution can optionally be admixed with phosphoric acid (most typically conc. phosphoric acid, 85%). This allows the viscosity to be adjusted to the desired value and the formation of the membrane to be facilitated.

The membrane obtained according to step C) has a thickness between 20 and 4000 μm, preferably between 30 and 3500 μm, in particular between 50 and 1000 μm.

### Step D)

The optionally heating in step D) can be required to secure proper polymerization of the polyazole polymer being formed. The heating is applied when the polymerization in step B) results in an inherent viscosity of less than 1.0 dl/g, preferably less than 1.5 dl/g to cause further polymerization up to an inherent viscosity of at least 1.5 dl/g, preferably of at least 2.0 dl/g, is obtained. Such heating is carried out at a temperature and for a time until the aforementioned inherent viscosity is at least 1.5 dl/g, preferably of at least 2.0 dl/g, is obtained.

In addition, the heating can be used to increase the concentration of the polyphosphoric/phosphoric acids being present which may face dilution due to the formation of water during the polycondensation.

Typically, the temperatures for heating in step D) are up to 350° C. for shorter periods of less than one hour, most suitable is heating up to 250° C. The time for such heating is typically from at least 10 minutes up to several hours (10 hours). However, a skilled polymer expert knows that the above conditions depend upon the reactivity of the particular monomers

### Polyazole Polymer:

The polymer formed in step B) contains:

(i) repeat units of the general formula (III) or (IV)

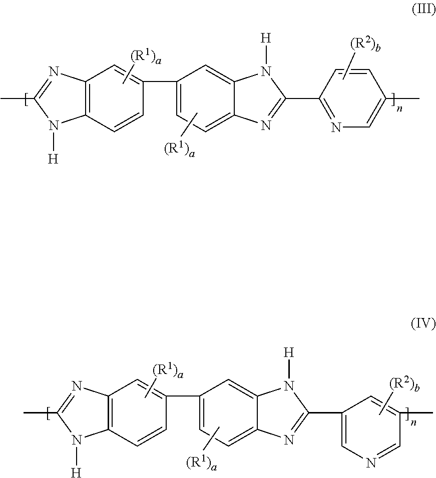

In which
R1 is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and
R2 hydrogen, fluorine an alkyl group having one to ten carbon atoms or an aryl group having 5 to 10 carbon atoms, in said alkyl group or aryl group one or more hydrogen atoms can be replaced by fluorine atoms, and
a is the same or different and is an integer of 0, 1, 2 or 3 and
b is the same or different and is an integer of 0, 1, 2, 3 or 4 and
n is an integer greater than or equal to 10, preferably greater than or equal to 100.
   and (ii) repeat units of the general formula (I), (II) or (V)

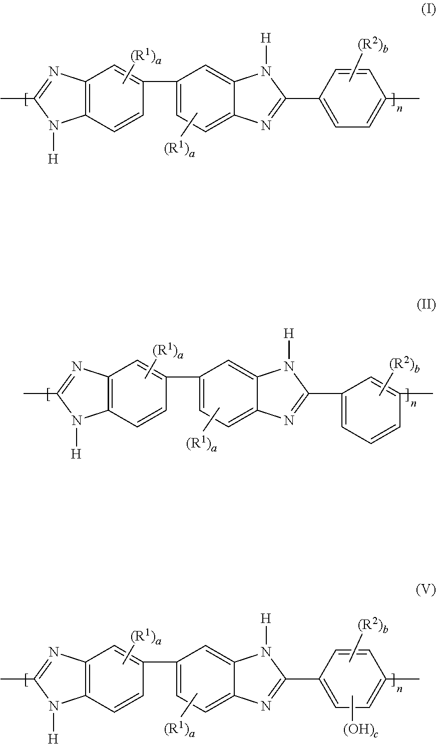

In which
R1 is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and, and
R2 is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and,
a is the same or different and is an integer of 0, 1, 2 or 3 and
b is the same or different and is an integer of 0, 1, 2, 3 or 4 with the proviso that b in formula (V) is an integer of 0, 1, 2 or 3 and the total of b and c is not more than 4,
c is the same or different and is an integer of 1 or 2, preferably 2, and
n is an integer greater than or equal to 10, preferably greater than or equal to 100,
   or is a homopolymer of the general formula (II)

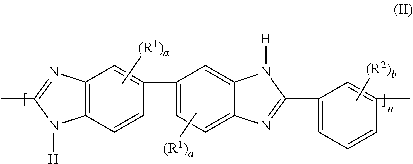

In which
R1 is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and, and
R2 is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and,
a is the same or different and is an integer of 0, 1, 2 or 3 and
b is the same or different and is an integer of 0, 1, 2, 3 or 4 and
n is an integer greater than or equal to 10, preferably greater than or equal to 100,

The polymer formed in step B) is either a random copolymer or a homopolymer.

The polymer formed in step B) contains (i) repeat units of the general formula (III) or (IV) and (ii) at least one repeat units of the general formula (I), (II) or (V) or is a homopolymer having repeat units of the general formula (II).

For the copolymer formed in step B) which contains repeat units of the general formula (III) [2,5py] and repeat units of the general formula (II) [m-PBI] the molar fraction of the repeat units of the general formula (II) is between 0.1 to 0.9, preferably between 0.5 to 0.9. Most preferred are molar fractions for formula (II) from 0.1 to 0.9 for a total monomer load (total amount of all aromatic tetraamino compounds and all aromatic carboxylic acids or esters thereof in step A) from 8% to 22% by weight and from 0.5 to 0.9 for a total monomer load (total amount of all aromatic tetraamino compounds and all aromatic carboxylic acids or esters thereof in step A) from 12% to 18% by weight.

For the copolymer formed in step B) which contains repeat units of the general formula (III) [2,5py] and repeat units of the general formula (I) [p-PBI] the molar fraction of the repeat units of the general formula (I) is between 0.02 to 0.5, preferably between 0.03 to 0.5, for a total monomer load (total amount of all aromatic tetraamino compounds and all aromatic carboxylic acids or esters thereof in step A) of at least 10% by weight. Most preferred are molar fractions for formula (I) from 0.05 to 0.5 for a total monomer load (total amount of all aromatic tetraamino compounds and all aromatic carboxylic acids or esters thereof in step A) from 10% to 12% by weight and from 0.04 to 0.25 for a total monomer load (total amount of all aromatic tetraamino compounds and all aromatic carboxylic acids or esters thereof in step A) from more than 10% to 16% by weight.

For the copolymer formed in step B) which contains repeat units of the general formula (III) [2,5py] and repeat units of the general formula (V), preferred formula (V) is 2OH-PBI, the molar fraction of the repeat units of the general formula (V), preferred formula (V) is 2OH-PBI, is between 0.1 to 0.4, preferably between 0.1 to 0.25. Most preferred are molar fractions for formula (V), preferred formula (V) is 2OH-PBI, from 0.1 to 0.25 for a total monomer load (total amount of all aromatic tetraamino compounds and all aromatic carboxylic acids or esters thereof in step A) from 8 to 12% by weight.

For the copolymer formed in step B) which contains repeat units of the general formula (IV) [3,5py] and repeat units of the general formula (I) [p-PBI] the molar fraction of the repeat units of the general formula (I) is between 0.3 to 0.85, preferably between 0.3 to 0.5, most preferred between 0.25 to 0.35, for a total monomer load (total amount of all aromatic tetraamino compounds and all aromatic carboxylic acids or esters thereof in step A) of at least 8% by weight, preferably at least 10% by weight. Most preferred are molar fractions for formula (I) from 0.3 to 0.85 for a total monomer load (total amount of all aromatic tetraamino compounds and all aromatic carboxylic acids or esters thereof in step A) from 8 to 12% by weight and from 0.3 to 0.5 for a total monomer load (total amount of all aromatic tetraamino compounds and all aromatic carboxylic acids or esters thereof in step A) from more than 12% to 16% by weight, and from 0.25 to 0.35 for a total monomer load (total amount of all aromatic tetraamino compounds and all aromatic carboxylic acids or esters thereof in step A) from more than 16% to 20% by weight.

For the copolymer formed in step B) which contains repeat units of the general formula (IV) [3,5py] and repeat units of the general formula (II) [m-PBI] the molar fraction of the repeat units of the general formula (II) is between 0.05 to 0.9, preferably between 0.25 to 0.9. Most preferred are molar fractions for formula (II) from 0.1 to 0.9 for a total monomer load (total amount of all aromatic tetraamino compounds and all aromatic carboxylic acids or esters thereof in step A) from 10 to 20% by weight and from 0.5 to 0.9 for a total monomer load (total amount of all aromatic tetraamino compounds and all aromatic carboxylic acids or esters thereof in step A) from more than 12% to 16% by weight, and from 0.05 to 0.4 for a total monomer load (total amount of all aromatic tetraamino compounds and all aromatic carboxylic acids or esters thereof in step A) from more than 16% to 20% by weight.

For the copolymer formed in step B) which contains repeat units of the general formula (IV) [3,5py] and repeat units of the general formula (V), preferred formula (V) is 2OH-PBI, the molar fraction of the repeat units of the general formula (V), preferred formula (V) is 2OH-PBI, is 0.5+/−20%. Most preferred are molar fractions for formula (II) of 0.5+/−10% for a total monomer load (total amount of all aromatic tetraamino compounds and all aromatic carboxylic acids or esters thereof in step A) of 12% (+/−5%) by weight.

For the homopolymer formed in step B) which contains repeat units of the general formula (II), the molar fraction of the repeat units of the general formula (II) is 1.0, preferred total monomer load (total amount of all aromatic tetraamino compounds and all aromatic carboxylic acids or esters thereof in step A) is from more than 12% to 20% by weight.

When the mixture according to step A) also comprises tricarboxylic acids or tetracarboxylic acid, this achieves branching/crosslinking of the polymer formed. This contributes to improving the mechanical properties.

### Step E):

The membrane obtained according to step C) or D), if the optional heating is performed, is treated in the presence of water and/or moisture (step E). Such treatment is a hydrolysis of the polyphosphoric/phosphoric acid being present from the preceding steps and causes a sol-gel transfer of the polyazole/polyphosphoric/phosphoric acid mixture. The hydrolysis treatment is performed at temperatures and for a time sufficient for the membrane to have sufficient strength for use in fuel cells. The treatment can be effected to the extent that the membrane is self-supporting, so that it can be removed from the carrier without damage.

The treatment of the membrane in step E) typically is done at temperatures above 0° C. and less than 150° C., preferably at temperatures between 10° C. and 120° C., in particular between room temperature (20° C.) and 90° C., in the presence of moisture and/or water and/or steam and/or aqueous phosphoric acid. The treatment is effected preferably under standard pressure, but may also be effected under the action of pressure. It is important that the treatment is done in the presence of sufficient moisture, as a result of which the polyphosphoric acid present contributes to the strengthening of the membrane by virtue of partial hydrolysis to form low molecular weight polyphosphoric acid and/or phosphoric acid.

The at least partial hydrolysis of the polyphosphoric acid in step E) leads to strengthening of the membrane and to a decrease in the layer thickness and formation of a membrane having a thickness between 15 and 3000 μm, preferably between 20 and 2000 μm, in particular between 20 and 1500 μm, which is self-supporting. The intra- and intermolecular structures present in the polyphosphoric acid layer (interpenetrating networks, IPN) lead to ordered membrane formation which draws responsible for the particular properties of the membranes formed.

The upper temperature limit of the treatment according to step E) is generally 150° C. In the case of extremely brief action of moisture, for example of superheated steam, this steam may also be hotter than 150° C. The essential condition for the upper temperature limit is the duration of treatment.

The treatment in step E) can also be effected in climate-controlled chambers in which the hydrolysis can be controlled under defined action of moisture. In this case, the moisture can be adjusted in a controlled manner by the temperature or saturation of the contacting environment, for example gases such as air, nitrogen, carbon dioxide or other suitable gases, or steam. The treatment time is dependent upon the parameters selected above. If the humidity of the environmental air is sufficient (typically 35-100% relative humidity), it is also possible to perform the hydrolysis at room temperatures (typically 20° C.).

The treatment time is also dependent upon the thickness of the membrane.

In general, the treatment time is between a few seconds to minutes, for example under reaction of superheated steam, or up to whole days, for example under air at room temperature and low relative atmospheric moisture. The treatment time is preferably between 10 seconds and 300 hours, in particular from 1 minute to 200 hours.

When the at least partial hydrolysis is carried out at room temperature (20° C.) with ambient air of relative atmospheric moisture content of 40-80%, the treatment time is between 5 and 200 hours.

The membrane obtained from step E) is typically self-supporting and can be removed from the carrier without damage and subsequently optionally be further processed directly. In case the membrane in step C) is formed on an electrode directly, the removal of any carrier in not required.

It is possible via the degree of hydrolysis, i.e. the time, temperature and atmospheric moisture content, to adjust the concentration of phosphoric acid and hence the conductivity of the inventive polymer membrane. According to the invention, the concentration of phosphoric acid is reported as mole of acid per mole of repeat unit of the polymer. In the context of the present invention, preference is given to a concentration (mole of phosphoric acid based on a repeat unit of polybenzimidazole) of at least 10, preferably of at least 15, in particular of at least 20.

It is known from WO02/071518 that such high degrees of doping (concentrations) are obtainable with greatest difficulties, if at all, by doping polyazoles films with commercially available ortho-phosphoric acid, because such later doping causes non-uniform membranes having portions in which the membrane is already dissolved by the acid, in particular phosphoric acid. On the other hand, the polyazole membranes described in WO 02/081547 exhibit high phosphoric acid content; however membranes suffer from limited mechanical properties, such as fluidification and creep, most likely due to the relative low total amount of polymers being present in the membrane, typically not more than 15% by weight.

The membrane obtained from step E) has a total amount of polymers being present which is at least 17.5% by weight, preferably 20% by weight, more preferred at least 25% by weight, and said total amount includes any acids, such as polyphosphoric acid and/or phosphoric acid and water being present, said total content excluding however any optional additives. Thus, the total amount of polymer being present is significantly higher than in WO 02/081547 due to the improved solubility of the instant copolymers

Thus, the current invention combines the superior conductivities as described in WO 02/081547 with good mechanical properties.

The membranes according to the current invention show a set of properties which in combination were not achieved before. The membranes according to the current invention have:
(a) the proton conductivity of the membrane without humidification is at least 100 mS/cm, preferably at least 110mS/cm, measured at 160° C., preferably 180° C.,
(b) the Young's Modulus of the membrane is at least 5 MPa
(c) the compliance J(20h) of the membrane is not more than 6 MPa⁻¹ at 180° C., preferably not more than 5 MPa⁻¹ at 180° C., most preferred not more than 4 MPa⁻¹ at 180° C.

The membranes according to the instant invention show higher Young's modulus compared to membrane known from International patent application WO 02/081547.

The membranes according to the current invention have a Young's modulus of at least 5.0 MPa, preferably at least 7.0 MPa, most preferred at least 9.0 MPa.

The Young's modulus is measured on a membrane having a thickness range of 150-600 microns.

The membranes according to the current invention have a compliance J(20h) of not more than 6 MPa⁻¹ at 180° C., preferably not more than 5 MPa⁻¹ at 180° C., most preferred not more than 4 MPa⁻¹ at 180° C., in particular between 4 and 1 MPa⁻¹ and a total amount of copolymers being present which is at least 17.5% by weight, preferably at least 20% by weight, most preferred at least 25% by weight, and said total amount includes any acids, such as polyphosphoric acid and/or phosphoric acid and water being present, said total content excluding however any optional additives.

The term compliance J(t) for t=20 hours, as used in the current invention, characterizes the creep response of a material under a constant applied stress, as measured in a creep compliance test.

The viscoelastic properties of polymer electrolyte membranes are critically important to their use in fuel cell applications. This is particularly true for polymer electrolyte membranes based on polyazoles, such as polybenzimidazole (FBI). As a part of a membrane-electrode assembly, such membrane is subjected to an initial compressive stress when the fuel cell stack is assembled. This compressive stress ensures that the membrane maintains intimate contact with the adjoining electrodes. Over time, the compressive stress in the membrane decreases (“relaxes”) due to time-dependent viscoelastic flow in compression, also known as creep. Over long periods of time, continuing creep and concomitant stress relaxation can result in the loss of intimate contact between the membrane and the adjoining electrodes as well as severe thinning of the membrane layer. Such thinning can cause separation between electrode and membrane layers and result in failure of the MEA and the fuel cell stack.

In order to prolong the service life of MEAs incorporating polymer electrolyte membranes based on polyazoles, such as polybenzimidazole (FBI), membrane compositions and structures that manifest minimal creep and stress relaxation are desired.

Those knowledgeable in the art of rheology recognize that one may measure time-dependent viscoelastic flow under compressive stress, or creep, using either of two equivalent methods, such as described in Ferry, J. D., Viscoelastic Properties of Polymers. Wiley: New York, 1980 and Dealy, J. M. and Wissbrun, K. F., Melt Rheology and its Role in Plastics Processing. Van Nostrand Reinhold: New York, 1990, the creep compression test and the stress relaxation test. In a creep compression test, a material sample is subjected (at time t=0) to a compressive stress σ₀ (units Pa, equal to the applied force in N divided by the sample's area in m²), which is held constant during the test. As the sample undergoes creep compression, the thickness of the sample, L(t), decreases from its initial value (L₀). The change in the sample thickness divided by the initial thickness,

$$s ( t ) = \frac{L ( t ) - {L}_{0}}{{L}_{0}}$$

is known as engineering strain. Those knowledgeable in the art understand that continuous compressive deformation requires the use of a more appropriate strain measure,

$$s ( t ) = ln [ \frac{L ( t )}{{L}_{0}} ] = ln [ 1 + s ( t ) ]$$

known as true strain or Hencky strain. Both engineering strain and true strain measure the amount of creep in a material but depend on the magnitude of the applied stress. A normalized measure of compressive creep is the strain divided by the stress,

$$J ( t ) = \begin{matrix}s ( t ) \\ {σ}_{2}\end{matrix}$$

known to those knowledgeable in the art as the creep compliance. The value of the creep compliance is used here as the direct measure of the tendency of a material to undergo viscoelastic creep under an applied compressive stress.

The stress relaxation test is similar to the creep compression test. In the stress relaxation test, one subjects the sample to a specified initial compressive strain and measures the time-dependent stress in the material. As creep occurs, the stress in the material decreases over time. Thus the stress relaxation test mimics the loading environment experienced by a membrane in a compressed fuel cell stack. However, at long times, the measured stress in the sample is small and subject to various sources of experimental error, making the stress relaxation test less preferred for long-term accelerated testing. We therefore prefer the creep compression test for long-term accelerated testing of material creep behavior.

Physically, the creep compliance J(t) (units 1/Pa) can be viewed as the reciprocal of a viscoelastic relaxation modulus G(t) (units Pa). To prolong the service life of a fuel cell stack and its MEAs, we desire membrane materials with a large compressive modulus, or—to those knowledgeable in the art—the smallest possible creep compliance.

The membranes described in WO 02/081547 show a compliance J(20h) of about 10.5 MPa⁻¹ and an initial polymer solid content of about 10% by weight. In contrast, the membranes according to the current invention have a compliance J(20h) of not more than 6 MPa⁻¹ at 180° C., preferably not more than 5 MPa⁻¹ at 180° C., most preferred not more than 4 MPa⁻¹ at 180° C., in particular between 4 and 1 MPa⁻¹, most preferred between 3 and 1 MPa⁻¹, and a total amount of copolymers being present which is at least 17.5% by weight, preferably at least 20% by weight, most preferred at least 25% by weight, and said total amount includes any acids, such as polyphosphoric acid and/or phosphoric acid and water being present, said total content excluding however any optional additives.

The current invention provides more robust proton conductive membranes which translate into more robust membrane-electrode assemblies while maintaining the other important properties, such as conductivity, electrochemical performance and durability. In particular, the current invention allows for the manufacture of membrane-electrode assemblies (MEA) which do not require a subgasket as disclosed in WO 2004/015797.

### Further Possible Treatment of the Membrane:

After the treatment according to step E) or F), the membrane can also be crosslinked on the surface by reaction of heat in the presence of atmospheric oxygen. This curing of the membrane surface improves the properties of the membrane additionally.

The crosslinking can also be effected by the action of IR or NIR (IR=infrared, i.e. light having a wavelength of more than 700 nm; NIR=near IR, i.e. light having a wavelength in the range from approx. 700 to 2000 nm or an energy in the range from approx. 0.6 to 1.75 eV). A further method is irradiation with β-rays. The radiation dose here is between 5 and 200 kGy.

The inventive polymer membrane has improved material properties compared to the doped polymer membranes known to date. In particular, due to their higher creep resistance, they exhibit better performance in comparison with known doped polymer membranes. In addition the inventive polymer membrane shows higher elastic-modulus as explained before.

Typically, the inventive polymer membrane show a good proton conductivity of at least 0.1 S/cm, preferably at least 0.11 S/cm, in particular at least 0.15 S/cm, measured at temperatures of 160° C., preferably at temperatures of 180° C., without additional humidification and without any additional proton-conducting filler.

However, to further improve the performance properties, it is additionally possible to add fillers, especially proton-conducting fillers, and also additional acids to the membrane. The addition may be effected either in step A), B), C) and/or D).

Nonlimiting examples of proton-conducting fillers are
Sulfates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
Phosphates such as Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
Polyacid such as H₃PW₁₂O₄₀.nH₂O (n=21-29), H₃SiW₁₂O₄₀.nH₂O (n=21-29), HₓWO₃, HSbWO₆, H₃PMo₁₂O₄₀, H₂Sb₄O₁₁, HTaWO₆, HNbO₃, HTiNbO₅, HTiTaO₅, HSbTeO₆, H₅Ti₄O₉, HSbO₃, H₂MoO₄
Selenites and arsenides such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
Oxides such as Al₂O₃, Sb₂O₅, ThO₂, SnO₂, ZrO₂, MoO₃
Silicates such as zeolites, zeolites(NH₄+), sheet silicates, framework silicates, H-natrolites, H-mordenites, NH₄-analcines, NH₄-sodalites, NH₄-gallates, H-montmorillonites
Acids such as HClO₄, SbF₅
Fillers such as carbides, in particular SiC, Si₃N₄, fibers, in particular glass fibers, glass powders and/or polymer powders being different from the described polyazoles.

In addition, this membrane may also contain perfluorinated sulfonic acid additives (0.1-20% by weight, preferably 0.2-15% by weight, very preferably 0.2-10% by weight). These additives lead to enhancement of performance, to an increase in the oxygen solubility and oxygen diffusion close to the cathode and to a reduction in the adsorption of phosphoric acid and phosphate on platinum. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and Perfluorosulfonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90.)

Nonlimiting examples of persulfonated additives are:

trifluoromethanesulfonic acid, potassium trifluoromethanesulfonate, sodium trifluoromethanesulfonate, lithium trifluoromethanesulfonate, ammonium trifluoromethanesulfonate, potassium perfluorohexanesulfonate, sodium perfluorohexanesulfonate, lithium perfluorohexanesulfonate, ammonium perfluorohexanesulfonate, perfluorohexanesulfonic acid, potassium nonafluorobutanesulfonate, sodium nonafluorobutane sulfonate, lithium nonafluorobutanesulfonate, ammonium nonafluorobutanesulfonate, cesium nonafluorobutanesulfonate, triethylammonium perfluorohexanesulfonate, perfluorosulfonimides and Nafion.

In addition, the membrane may also comprise as additives which scavenge (primary antioxidants) or destroy (secondary antioxidants) the peroxide radicals generated in oxygen reduction in the course of operation and thus, as described in JP2001118591 A2, improve lifetime and stability of the membrane and membrane-electrode unit. The way in which such additives function and their molecular structures are described in F. Gugumus in Plastics Additives, Hanser Verlag, 1990; N. S. Allen, M. Edge Fundamentals of Polymer Degradation and Stability, Elsevier, 1992; or H. Zweifel, Stabilization of Polymeric Materials, Springer, 1998. Nonlimiting examples of such additives are:

bis(trifluoromethyl)nitroxide, 2,2-diphenyl-1-picrinylhydrazyl, phenols, alkylphenols, sterically hindered alkylphenols, for example Irganox, aromatic amines, sterically hindered amines, for example Chimassorb; sterically hindered hydroxylamines, sterically hindered alkylamines, sterically hindered hydroxylamines, sterically hindered hydroxylamine ethers, phosphites, for example Irgafos, nitrosobenzene, methyl-2-nitrosopropane, benzophenone, benzaldehyde tert-butyl nitron, cysteamine, melanines, lead oxides, manganese oxides, nickel oxides, cobalt oxides.

Possible fields of use of the inventive doped polymer membranes include use in fuel cells, in electrolysis, in capacitors and in battery systems. Owing to their property profile, the proton conductive polymer membranes are preferably used in fuel cells.

The present invention also relates to a membrane-electrode unit which has at least one inventive polymer membrane. For further information about membrane-electrode units, reference is made to the technical literature, especially to the patents U.S. Pat. No. 4,191,618, U.S. Pat. No. 4,212,714 and U.S. Pat. No. 4,333,805. The disclosure present in the aforementioned references, U.S. Pat. No. 4,191,618, U.S. Pat. No. 4,212,714 and U.S. Pat. No. 4,333,805, with regard to the construction and the production of membrane-electrode units, and also the electrodes, gas diffusion layers and catalysts to be selected, also forms part of the description.

In one variant of the present invention, the membrane can also be formed directly on the electrode instead of on a carrier. This allows the treatment according to step E) to be shortened appropriately, since the membrane no longer has to be self-supporting. Such a membrane also forms part of the subject matter of the present invention.

The present invention further provides an electrode which having a proton-conducting polymer coating based on polyazoles, obtainable by a process comprising the steps of
A) mixing:
   (i) at least one aromatic tetraamino compounds and
   (ii) at least two different aromatic carboxylic acids or esters thereof which contain at least two acid groups per carboxylic acid monomer,
   or
   (iii) at least one aromatic tetraamino compounds and
   (iv) one aromatic carboxylic acids or esters thereof which contain at least two acid groups per carboxylic acid monomer, in polyphosphoric acid to form a solution and/or dispersion
B) heating the mixture from step A), preferably under inert gas, and polymerizing until an inherent viscosity of at least 0.8 dl/g, preferably at least 1.0 dl/g, in particular at least 1.5 dl/g, is obtained for the copolymer being formed,
C) applying a membrane layer using the mixture according to step B) on an electrode,
D) optionally heating the membrane on the electrode obtained from step C),
E) treating the membrane formed in the presence of water and/or moisture, characterized in that
F) one of the at least two different aromatic carboxylic acids or esters thereof which contain at least two acid groups per carboxylic acid monomer (first aromatic carboxylic acid) is pyridine-2,5-dicarboxylic acid or pyridine-3,5-dicarboxylic acid, and
G) one of the at least two different aromatic carboxylic acids or esters thereof which contain at least two acid groups per carboxylic acid monomer (second aromatic carboxylic acid) is selected from terephthalic acid, isophthalic acid, di-hydroxy-benzene-1,4-dicarboxylic acid, di-hydroxy-benzene-1,3-dicarboxylic acid, or di-hydroxy-benzene-1,2-dicarboxylic acid,
   OR
H) one of the at least two different aromatic carboxylic acids or esters thereof which contain at least two acid groups per carboxylic acid monomer (first aromatic carboxylic acid) is terephthalic acid and
I) one of the at least two different aromatic carboxylic acids or esters thereof which contain at least two acid groups per carboxylic acid monomer (second aromatic carboxylic acid) isophthalic acid,
   OR
J) said one aromatic carboxylic acids monomer being isophthalic acid or an esters thereof,
K) the molar fraction of said first aromatic carboxylic acid is between 0.1 to 0.9, preferably 0.1 to 0.5, and
L) the molar fraction of said second aromatic carboxylic acid is chosen so that the sum of the molar fraction of the first aromatic carboxylic acid and the molar fraction of the second aromatic carboxylic acid is 1.0,
M) the total amount of all aromatic tetraamino compounds and all aromatic carboxylic acids or esters thereof in step A) is chosen so that the total amount of the copolymers being present is at least 17.5% by weight, preferably 20% by weight, more preferred at least 25% by weight, and said total amount includes any acids, such as polyphosphoric acid and/or phosphoric acid and water being present, said total content excluding however any optional additives.

The variants and preferred embodiments described above are also valid for this subject matter, so that there is no need to repeat them at this point.

After step E), the membrane has a thickness between 2 and 3000 μm, preferably between 3 and 2000 μm, in particular between 5 and 1500 μm.

### General Test Methods:

### Test Method for Creep Compliance J(t)

The test specimens for the creep compression test are circular disks of polyazole membrane material that are 6.3 mm in diameter and 0.9-1.2 mm in thickness. Depending on the thickness of the individual membranes, several membranes are stacked to achieve the aforementioned thickness range. Prior to the creep compression test, the specimens were conditioned to remove water. For this purpose, we prepared two identical sample conditioning rigs, each consisting of two cylindrical PTFE blocks with smooth surfaces, a metal support frame and an alignment screw. A specimen was centered on the flat surface of one PTFE block, and then the other PTFE block was moved, via the adjustment screw, just into contact with the specimen with minimal application of force. The two identical rigs, each containing specimens of the same polyazole membrane material, were transferred to an air oven for conditioning at 180° C. for 24 hours. After conditioning, one sample was titrated with sodium hydroxide, then dried and weighed to determine the polymer solids loading (expressed as weight percent, with the balance consisting of phosphoric acid). This composition was termed the “initial” composition. The other identically conditioned sample was characterized in the creep compression test. Because compression results in expulsion of some phosphoric acid from the material, we also measure the sample composition (“final”) after the creep compression test.

The creep compression tests were performed using a dynamic mechanical analyzer or DMA (model RSA-III, TA Instruments, Inc.). The compression fixture consisted of a pair of axially-aligned, cylindrical metal plates that were surface-coated with polytetrafluoroethylene (PTFE or Teflon®). Before the test, a conditioned specimen (still hot) was transferred from the oven onto the pre-heated lower plate in the RSA-III. The specimen diameter was re-measured using an electronic digital caliper. With the RSA-III temperature set at 180° C., the upper plate was lowered until it touched the specimen surface with an applied force of about 0.001 N. At this point, distance between the plates (as indicated by the RSA-III) was identified as the initial thickness (L₀) of the specimen. The specimen was equilibrated at 180° C. for at least 15 minutes prior to the application of compressive force. At the start of the actual creep compression test (t₀=0), a compressive stress (typically 0.1 MPa) was applied and held constant for a period of 20 hours (t₁=20 h). From t₀ to t₁, the specimen underwent creep deformation. The RSA-III maintains a constant applied stress and records the specimen thickness, L(t), as a function of time. The creep compliance J(t) may be determined from the measured L(t) as described previously.

Here, we use J(20 h), the value of the creep compliance recorded at t₁=20 h, as our preferred figure of merit for assessing the magnitude of creep deformation manifested by polyazole polymers under an applied compressive stress.

After creep compression for 20 hours, the compressive stress on the specimen was reduced to approximately zero, but we continued to record the thickness of the specimen for another 3 hours (t₂=23 hours). Upon removal of the compressive stress, the specimen thickness generally increased due to the elasticity of the polymer, yielding additional information of academic interest. At the end of this creep recovery test, the sample was removed from the compression fixture and then titrated with sodium hydroxide, dried and weighed to determine its final composition, namely the polymer solids content (expressed as weight percent).

### Test Method for Ionic Conductivity

Ionic conductivities were measured via a four-probe through-plane bulk measurement using an AC Zahner IM6e impedance spectrometer that scanned a frequency range from 1 Hz to 100 KHz. A rectangular sample of membrane (3.5 cm×7.0 cm) was placed in a glass or polysulfone cell with four platinum wire current collectors. Two outer electrodes set 6.0 cm apart supplied current to the cell, while the two inner electrodes 2.0 cm apart on opposite sides of the membrane measured the voltage drop. To ensure a through-plane bulk measurement of the membrane ionic conductivity, the two outer electrodes are placed on opposite sides of the membrane and the two inner electrodes are arranged in the same manner. The reported conductivities were of preconditioned (dehydrated) membranes that were held at >100° C. for at least two hours. Proton conductivity was calculated using the following equation:

σ=D/(L*B*R)

Where D was the distance between the two test current electrodes, L was the thickness of the membrane, B was the width of the membrane, and R was the measured resistance. The membrane contains no additional proton-conducting fillers.

The mechanical properties of the membranes were measured by cutting dog bone specimens (ASTM D683 Type V) from the bulk membrane using a cutting press. Tensile properties were measured using an Instron Tensile Tester (5543A) with a 10N load cell. All measurements were made at room temperature on samples preloaded to 0.1 N with a crosshead speed of 5 mm per minute.

### Test Method for Fuel Cell Performance

Fuel cell performance was measured in 50 cm² (active area 45.15 cm²) single stack fuel cells using test stations obtained from Plug Power or purchased from Fuel Cell Technologies. Polarization curves were obtained at various temperatures (120-180° C.) with hydrogen as a fuel and different oxidants (air or oxygen gas). Fuel cells were operated for at least 100 hours (break-in period) at 0.2 A/cm² at 180° C. before measurement of polarization curves. Long term stability testing was performed under static current and temperature conditions of 0.2 A/cm² and 180° C. with a constant flow rate of hydrogen (1.2 stoichiometric ratio) and air (2.0 stoichiometric ratio).

If the MEA failed, it was due to extreme thinning of the membrane due to the thermal instability of the membrane.

### Test Method for Inherent Viscosity

The inherent viscosity was measured by placing a small amount of polymer solution from step B) into distilled water for 24 hours. The precipitated polymer was then pulverized in a commercial Waring blender and neutralized with ammonium hydroxide in 500 mL of distilled water. After heating for 1 hour at 100° C., the polymer was isolated by filtration and washed thoroughly with water to remove any residual ammonium salts. The powder was then dried for 12 hours at 120-130° C. Solutions for inherent viscosity measurement were prepared by dissolving the neutralized polymer in concentrated sulfuric acid (96%) at a concentration of 0.2 g/dL. Inherent viscosity was measured by recording the flow times in the viscometer for the polymer solution and pure sulfuric acid using a suspended level Ubbelohde viscometer, size 200, at 30.0° C. in a temperature controlled water bath and was calculated according to the following equation:

ln(t/t₀)/c=inherent viscosity (dL/g)
t (sec): solution flow time
t₀ (sec): solvent flow time (96% sulfuric acid)
c (g/dL): solution concentration

### Test Method for Titration

The composition of the membrane was determined by titration with 0.1 M sodium hydroxide. The 0.1 M sodium hydroxide solution was prepared by dissolving 4 g sodium hydroxide in 1 liter distilled water and standardized by titration with a known amount of potassium hydrogen phthalate (predried at 110° C. for 1 hour). At least three circular samples with a diameter of 2 cm were cut from the bulk membrane. Every sample was weighed to obtain the initial weight, and then placed in 20 mL of distilled water and allowed to stir for at least 30 minutes. The samples were titrated using a Metrohm 716 DMS Titrino titrator. The first equivalence point was used to determine the volume of sodium hydroxide necessary for neutralization. The samples were washed thoroughly with distilled water and dried in a vacuum oven at 110° C. for at least eight hours. The samples were allowed to cool to room temperature in the vacuum oven before removal and were weighed to obtain the dry weight of the polymer.

Phosphoric acid doping levels, X, moles of phosphoric acid per mole of FBI repeat unit (XH₃PO₄/PBI) were calculated from the equation:

$$X = \frac{( {V}_{NaOH} \times {C}_{NaOH} )}{( {W}_{dry} / {M}_{polymer} )}$$

where V_{NaOH} and C_{NaOH} are the volume and concentration of the sodium hydroxide solution required to neutralize the phosphoric acid to the first equivalence point, W_{dry} is the dry weights of the polymer sample, and M_{polymer} is the molecular weights of the polymer repeat unit.

The polymer weight percentage, phosphoric acid weight percentage, water weight percentage, and the concentration of phosphoric acid of the tested membranes were determined by the equations below:

$$polymer \% = \frac{{W}_{dry}}{{W}_{sample}} \times 100$$

$$acid \% = \frac{{M}_{acid} \times {V}_{NaOH} \times {C}_{NaOH}}{{W}_{sample}} \times 100$$

$$water \% = \frac{{W}_{sample} - {W}_{dry} - {M}_{acid} \times {V}_{NaOH} \times {C}_{NaOH}}{{W}_{sample}} \times 100$$

$${Concentration}_{acid} \% = \frac{{W}_{acid}}{{W}_{acid} + {W}_{{H}_{2} O}} \times 100 = \frac{{M}_{acid} \times {V}_{NaOH} \times {C}_{NaOH}}{{W}_{sample} - {W}_{dry}} \times 100$$

where V_{NaOH} and C_{NaOH} are the volume and concentration of the sodium hydroxide solution required to neutralize the phosphoric acid to the first equivalence point, M_{acid} is the molecular weights of phosphoric acid, W_{dry} is the dry weight of the polymer sample, and Wₛₐₘₚₗₑ is the total weight of the testing sample.

### EXAMPLES

International patent application WO02/081547

### Example 1

95 g para-PBI/PPA solution (BASF Fuel cell) was obtained in accordance with International patent application WO 02/081547, except that the monomer concentration was raised so that the final para-PBI/PPA solution had a concentration of 5.6 wt % of para-PBI). Such solution was pre-heated at 160° C. under dry nitrogen. 5 ml of 85% phosphoric acid was added dropwise to reduce the solution viscosity. Slight vacuum was applied to remove the bubbles from the system. The temperature was increased to 200° C. for 30 minutes, and then was cast using a 25 mil gap casting blade onto clear glass plates. The cast membrane was hydrolyzed at 25° C., 55% relative humidity (RH) for 24 hours.

### Example 2

3.214 g tetraaminobiphenyl (TAB, 15 mmol) and 2.492 g terephthalic acid (TPA, 15 mmol) was added to 137 g polyphosphoric acid [PPA concentration 116%], mixed with overhead stirrer, purged with dry nitrogen. The mixture was heated at 150° C. for 3 hours, 170° C. for 3 hours, and then 195° C. for 12 hours. 5 ml of 85% phosphoric acid was added dropwise to reduce the solution viscosity. Temperature increased to 220° C. for half an hour before the casting.

The polymer solution (having a total solids content of FBI of 3.26 wt %) was casted onto clear glass plates. The cast membrane was hydrolyzed in 65% phosphoric acid bath for 24 hours. This example corresponds to the membranes known from International patent application WO 02/081547.

The mechanical properties of the membranes were measured by cutting dog bone specimens (ASTM D683 Type V) as described earlier.

| | | Strain at | | |
|---|---|---|---|---|
| | Thickness | Max. Load | Young's Modulus | Modulus |
| sample | (mm) | (mm/mm) | (MPa) | (MPa) |
| Example 1 | 0.43 | 2.334 | 4.904 | 1.562 |
| Example 2 | 0.36 | 4.908 | 1.863 | 0.865 |

The higher modulus means that higher resistance to flow/creep of the membranes is obtained.

### Example 3

### 1. 2,5-Pyridine-r-Meta-PBI

To a three-necked flask equipped with nitrogen flow and overhead stirrer, a solution of 2,5-pyridinedicarboxylic acid (4.734 g, 9 equiv.), isophthalic acid (0.523 g, 1 equiv.), tetraaminobiphenyl (6.744 g, 10 equiv.), and polyphosphoric acid (88 g) was stirred and heated to 195° C. for 11 hours. Following completion of the polymerization process, the FBI solution was poured onto a glass plate and cast at a thickness of 15 mil using a Gardner blade. To form a gel membrane, the glass plates with the cast films were immediately placed into a humidity controlled chamber at 55%±5% relative humidity (RH), 25±2° C. Complete hydrolysis of the membrane occurred over a span of 24h. The final gel membrane thickness was approximately 386 μm. The inherent viscosity of the polymer was 1.41 dL/g.

The composition of acid-doped FBI membranes was determined by measuring the relative amounts of polymer solids, water, and acid in the film. The phosphoric acid (PA) content was determined by titrating a sample of membrane with standardized sodium hydroxide solution (0.1 N) using a Metrohm 716 DMS Titrino autotitrator. The sample was washed with water and dried in a vacuum oven overnight at 120° C. The dried sample was then weighed to determine polymer solids content for the membrane. The amount of water was calculated by subtracting the weights of polymer and PA from the initial FBI membrane sample weight. The final composition of the membrane was 52.33 wt % phosphoric acid, 13.73 wt % polymer, and 33.94% water.

The tensile properties of the membranes were tested at room temperature as described earlier. The Young's modulus of this membrane was 9.65 MPA and had a strain at break of 0.58 mm/mm (58% elongation) at room temperature.

Ionic conductivities were measured via a four-probe through-plane bulk measurement using an AC Zahner IM6e impedance spectrometer as described earlier. The anhydrous proton conductivity of this membrane was 0.14 S/cm at 180° C.

Membrane electrode assemblies consisted of the polymer membrane sandwiched between two electrodes. MEAs were prepared by hot pressing the acid-doped membrane between an anode electrode and a cathode electrode at 150° C. for 90-150 seconds using 4500 lbs of force and compressing to 80% its original width. Electrodes were received from BASF Fuel Cell, Inc. with 1.0 mg/cm² platinum (Pt) catalyst loading. Anode electrodes contained only Pt as the catalyst, while the cathode electrodes contain a BASF Fuel Cell standard cathode Pt alloy. The active area of the electrodes was 45.15 cm². Fuel cell fabrication was conducted by assembling the cell components as follows: end plate:anode current collector:anode flow field:MEA:cathode flow field:cathode current collector:end plate. Gaskets were used on either side of the MEA to control compression. Following assembly, the cell was evenly clamped to 50 in-lbs of pressure.

Fuel cell performance was measured in 50 cm² (active area 45.15 cm²) single stack fuel cells using test stations obtained from Plug Power or purchased from Fuel Cell Technologies as described earlier.

The MEA constructed from the 9:1 2,5-Pyridine-r-Meta-PBI membrane exhibited a fuel cell performance of 0.60 V following a 100h break-in period under constant operation at 0.2 A/cm² with H₂:Air=1.2:2.0 stoichiometric ratios.

### Example 4

### 2,5-Pyridine-r-Meta-PBI

To a three-necked flask equipped with nitrogen flow and overhead stirrer, a solution of 2,5-pyridinedicarboxylic acid (0.527 g, 1 equiv.), isophthalic acid (4.715 g, 9 equiv.), tetraaminobiphenyl (6.758 g, 10 equiv.), and polyphosphoric acid (88 g) was stirred and heated to 195° C. for 9 hours. Following completion of the polymerization process, the PBI solution was poured onto a glass plate and cast at a thickness of 15 mil using a Gardner blade. To form a gel membrane, the glass plates with the cast films were immediately placed into a humidity controlled chamber at 55%±5% relative humidity (RH), 25±2° C. Complete hydrolysis of the membrane occurred over a span of 24 h. The final gel membrane thickness was approximately 300 μm. The final composition of the membrane was 52.75 wt % phosphoric acid, 18.90 wt % polymer, and 28.35 wt % water. The inherent viscosity of the polymer was 0.94 dL/g. The Young's Modulus of the membrane was 6.55 MPa, and its tensile strain at break was 3.235 mm/mm. The anhydrous proton conductivity of the membrane was 0.11 S/cm at 180° C., and following break-in, the MEA constructed from the 1:9 2,5-Pyridine-r-Meta-PBI membrane exhibited a fuel cell performance of 0.66 V following a 100h break-in period under constant operation at 0.2 A/cm² with H₂:Air=1.2:2.0 stoichiometric ratios.

### Example 5

### 2,5-Pyridine-r-2OH-PBI

To a three-necked flask equipped with nitrogen flow and overhead stirrer, a solution of 2,5-pyridinedicarboxylic acid (4.323 g, 5 equiv.), 2,5-dihydroxyterephthalic acid (1.025 g, 1 equiv.), tetraaminobiphenyl (6.652 g, 6 equiv.), and polyphosphoric acid (88 g) was stirred and heated to 195° C. for 6.5 hours. Following completion of the polymerization process, the FBI solution was poured onto a glass plate and cast at a thickness of 15 mil using a Gardner blade. To form a gel membrane, the glass plates with the cast films were immediately placed into a humidity controlled chamber at 55%±5% relative humidity (RH), 25±2° C. Complete hydrolysis of the membrane occurred over a span of 24h. The final gel membrane thickness was approximately 509 μm. The final composition of the membrane was 51.68 wt % phosphoric acid, 14.99 wt % polymer, and 33.33 wt % water. The Young's Modulus of the membrane was 12.70 MPa, and its tensile strain at break was 0.458 mm/mm. The proton conductivity of the membrane was 0.16 S/cm at 180° C., and following break-in, the MEA constructed from the 5:1 2,5-Pyridine-r-2OH-PBI membrane exhibited a fuel cell performance of 0.64 V following a 100h break-in period under constant operation at 0.2 A/cm² with H₂:Air=1.2:2.0 stoichiometric ratios.

### Example 6

### 3,5-Pyridine-r-Para-PBI

To a three-necked flask equipped with nitrogen flow and overhead stirrer, a solution of 3,5-pyridinedicarboxylic acid (0.878 g, 1 equiv.), terephthalic acid (4.365 g, 5 equiv.), tetraaminobiphenyl (6.756 g, 6 equiv.), and polyphosphoric acid (88 g) was stirred and heated to 195° C. for 13 hours. Following completion of the polymerization process, the FBI solution was poured onto a glass plate and cast at a thickness of 15 mil using a Gardner blade. To form a gel membrane, the glass plates with the cast films were immediately placed into a humidity controlled chamber at 55%±5% relative humidity (RH), 25±2° C. Complete hydrolysis of the membrane occurred over a span of 24h. The final gel membrane thickness was approximately 294 μm. The final composition of the membrane was 56.00 wt % phosphoric acid, 14.87 wt % polymer, and 29.13 wt % water. The inherent viscosity of the polymer was 1.37 dL/g. The Young's Modulus of the membrane was 9.041 MPa, and its tensile strain at break was 0.638 mm/mm. The anhydrous proton conductivity of the membrane was 0.16 S/cm at 180° C., and following break-in, the MEA constructed from the 1:5 3,5-Pyridine-r-Para-PBI membrane exhibited a fuel cell performance of 0.65 V following a 100h break-in period under constant operation at 0.2 A/cm² with H₂:Air=1.2:2.0 stoichiometric ratios.

### Example 7

### 2,5-Pyridine-r-2OH-PBI

To a three-necked flask equipped with nitrogen flow and overhead stirrer, a solution of 2,5-pyridinedicarboxylic acid (3.865 g, 3 equiv.), 2,5-dihydroxyterephthalic acid (1.527 g, 1 equiv.), tetraaminobiphenyl (6.607 g, 4 equiv.), and polyphosphoric acid (88 g) was stirred and heated to 195° C. for 4.5 hours. Following completion of the polymerization process, the FBI solution was poured onto a glass plate and cast at a thickness of 15 mil using a Gardner blade. To form a gel membrane, the glass plates with the cast films were immediately placed into a humidity controlled chamber at 55%±5% relative humidity (RH), 25±2° C. Complete hydrolysis of the membrane occurred over a span of 24h. The final gel membrane thickness was approximately 400 μm. The final composition of the membrane was 50.05 wt % phosphoric acid, 13.17 wt % polymer, and 36.78 wt % water. The Young's Modulus of the membrane was 13.42 MPa, and its tensile strain at break was 0.61 mm/mm. The anhydrous proton conductivity of the membrane was 0.16 S/cm at 180° C., and following break-in, the MEA constructed from the 3:1 2,5-Pyridine-r-2OH-PBI membrane exhibited a fuel cell performance of 0.60 V following a 100h break-in period under constant operation at 0.2 A/cm² with H₂:Air=1.2:2.0 stoichiometric ratios.

TABLE 1
(Copolymer of (III) and (II) [2,5py/meta]

| Total | mol | Film | Thermally | | PA/PRU | | Young's | Strain at | |
|---|---|---|---|---|---|---|---|---|---|
| monomer | fraction | forming | stable | Performance | (mole | Conductivity | Modulus | Break | Thickness |
| (weight %) | of (II) | (y/n) | (y/n) | @0.2 A/cm2 | ratio) | @180 C. | (MPa) | (mm/mm) | (mm) |
| 12% | 0.1 | Yes | Yes | 0.6 | 12.025 | 0.143 | 9.649 | 0.581 | 0.386 |
| 12% | 0.25 | Yes | Yes | 0.6 | 11.597 | 0.22 | 7.219 | 1.385 | 0.385 |
| 12% | 0.5 | Yes | Yes | 0.34 | 9.891 | 0.136 | 6.849 | 0.209 | 0.342 |
| 12% | 0.75 | Yes | Yes | 0.48 | 9.085 | 0.115 | 7.729 | 0.296 | 0.306 |
| 12% | 0.9 | Yes | Yes | 0.66 | 8.787 | 0.112 | 6.548 | 3.235 | 0.3 |
| 16% | 0.1 | Yes | Yes | 0.48 | 8.756 | | 19.051 | 0.353 | 0.373 |
| 16% | 0.25 | Yes | Yes | 0.4 | 9.165 | 0.179 | 14.774 | 0.426 | 0.476 |
| 16% | 0.5 | Yes | Yes | | 7.594 | 0.117 | 16.4 | 0.201 | 0.36 |
| 16% | 0.75 | No | | | | | | | |
| 16% | 0.9 | No | | | | | | | |

TABLE 2
(Copolymer of (III) and (I) [2,5py/para]

| Total | mol | Film | Thermally | | PA/PRU | | Young's | Strain at | |
|---|---|---|---|---|---|---|---|---|---|
| monomer | fraction | forming | stable | Performance | (mole | Conductivity | Modulus | Break | Thickness |
| (weight %) | of (I) | (y/n) | (y/n) | @0.2 A/cm2 | ratio) | @180 C. | (MPa) | (mm/mm) | (mm) |
| 10% | 0.83 | Yes | Yes | | 11.7 | 0.16 | 8.59 | 1.804 | 0.4 |
| 12% | 0.0625 | Yes | Yes | 0.61 | 10.814 | 0.158 | 13.052 | 0.358 | 0.398 |
| 12% | 0.1 | Yes | Yes | 0.62 | 10.237 | 0.149 | 12.09 | 0.292 | 0.395 |
| 12% | 0.17 | Yes | Yes | | 9.768 | 0.122 | 12.172 | 0.67 | 0.364 |
| 12% | 0.25 | Yes | Yes | 0.63 | 12.503 | 0.129 | 9.054 | 0.312 | 0.405 |
| 12% | 0.33 | Yes | Yes | 0.65 | 11.049 | 0.111 | 25.172 | 0.529 | 0.444 |
| 12% | 0.5 | Yes | Yes | 0.55 | 10.296 | 0.135 | 9.354 | 0.163 | 0.345 |
| 12% | 0.6 | | | | | | | | |
| 12% | 0.66 | | | | | | | | |
| 12% | 0.75 | | | | | | | | |
| 16% | 0.042 | Yes | Yes | 0.47 | 9.1 | | 20.486 | 0.108 | 0.386 |
| 16% | 0.0625 | Yes | Yes | 0.59 | 8.4 | | 20.211 | 0.096 | 0.379 |
| 16% | 0.1 | Yes | Yes | 0.53 | 8 | | 20.42 | 0.101 | 0.409 |
| 16% | 0.17 | Yes | Yes | 0.47 | 7.9 | | 17.791 | 0.158 | 0.446 |
| 16% | 0.25 | Yes | Yes | | 8.6 | | 16.431 | 0.0375 | 0.398 |
| 16% | 0.33 | | | | | | | | |
| 16% | 0.5 | | | | | | | | |

TABLE 3
(Copolymer of (III) and (V) [2,5py/2OH]

| Total | mol | Film | Thermally | | PA/PRU | | Young's | Strain at | |
|---|---|---|---|---|---|---|---|---|---|
| monomer | fraction | forming | stable | Performance | (mole | Conductivity | Modulus | Break | Thickness |
| (weight %) | of (V) | (y/n) | (y/n) | @0.2 A/cm2 | ratio) | @180 C. | (MPa) | (mm/mm) | (mm) |
| 12% | 0.1 | Yes | Yes | | 12.34 | 0.159 | 13.752 | 0.303 | 0.367 |
| 12% | 0.17 | Yes | Yes | 0.64 | 11.064 | 0.163 | 12.702 | 0.458 | 0.509 |
| 12% | 0.25 | Yes | Yes | 0.6 | 12.329 | 0.164 | 13.418 | 0.611 | 0.4 |
| 12% | 0.5 | No | | | | | | | |

TABLE 4
(Copolymer of (IV) and (I) [3,5py/para]

| Total | mol | Film | Thermally | | PA/PRU | | Young's | Strain at | |
|---|---|---|---|---|---|---|---|---|---|
| monomer | fraction | forming | stable | Performance | (mole | Conductivity | Modulus | Break | Thickness |
| (weight %) | of (I) | (y/n) | (y/n) | @0.2 A/cm2 | ratio) | @180 C. | (MPa) | (mm/mm) | (mm) |
| 8% | 0.83 | Yes | Yes | | 16.7 | 0.2 | 6.192 | 0.524 | 0.322 |
| 10% | 0.83 | Yes | Yes | | 11.2 | | 8.094 | | 0.32 |
| 12% | 0.17 | Yes | No | | 12.377 | | | 5.244 | 0.683 |
| 12% | 0.25 | Yes | No | | 11.324 | | | 3.508 | 0.415 |
| 12% | 0.33 | Yes | Yes | 0.58 | 11.32 | 0.136 | 11.022 | 1.213 | 0.379 |
| 12% | 0.5 | Yes | Yes | 0.57 | 11.6 | 0.17 | 6.481 | 1.734 | 0.385 |
| 12% | 0.66 | Yes | Yes | 0.53 | 9.68 | 0.102 | 8.151 | 1.454 | 0.39 |
| 12% | 0.66 | Yes | Yes | 0.45 | 9.53 | | 10.812 | 0.401 | 0.358 |
| 12% | 0.83 | Yes | Yes | 0.65 | 11.86 | 0.159* | 9.041 | 0.638 | 0.294 |
| 12% | 0.875 | No | | | | | | | |
| 12% | 0.92 | No | | | | | | | |
| 16% | 0.17 | Yes | No | | 3.171 | | 6.778 | 0.845 | 0.4 |
| 16% | 0.25 | Yes | No | | 10.518 | 0.101 | 10.682 | 0.284 | 0.44 |
| 16% | 0.33 | Yes | Yes | 0.55 | 7.887 | | 10.448 | 0.664 | 0.412 |
| 16% | 0.5 | Yes | Yes | 0.58 | 9.53 | 0.103 | 5.489 | 0.085 | 0.35 |
| 16% | 0.67 | No | | | | | | | |
| 16% | 0.75 | No | | | | | | | |
| 16% | 0.77 | No | | | | | | | |
| 16% | 0.875 | No | | | | | | | |
| 20% | 0.0625 | Yes | No | | 6.99 | | 20.286 | 0.203 | 0.457 |
| 20% | 0.1 | Yes | No | | 7.62 | | 26.389 | 0.257 | 0.46 |
| 20% | 0.17 | Yes | No | | 7.97 | | 16.805 | 0.169 | 0.492 |
| 20% | 0.25 | Yes | Yes | 0.51 | 7.75 | | 17.501 | 0.095 | 0.508 |
| 20% | 0.33 | Yes | Yes | 0.2 | 6.98 | | 42.536 | 0.141 | 0.474 |
| 20% | 0.5 | No | | | | | | | |
| 20% | 0.6 | No | | | | | | | |

TABLE 5
(Copolymer of (IV) and (II) [3,5py/meta]

| Total | mol | Film | Thermally | | PA/PRU | | Young's | Strain at | |
|---|---|---|---|---|---|---|---|---|---|
| monomer | fraction | forming | stable | Performance | (mole | Conductivity | Modulus | Break | Thickness |
| (weight %) | of (II) | (y/n) | (y/n) | @0.2 A/cm2 | ratio) | @180 C. | (MPa) | (mm/mm) | (mm) |
| 12% | 0.1 | Yes | No | | 11.321 | 0.11 | 11.689 | 2.66 | 0.372 |
| 12% | 0.25 | Yes | No | 0.36 | 8.748 | | | 5 | 0.34 |
| 12% | 0.5 | Yes | No | | 7.047 | | 12.87 | 7.05 | 0.345 |
| 12% | 0.75 | Yes | No | 0.36 | 10.45 | 0.14 | | | |
| 12% | 0.9 | No | No | | | | | | |
| 16% | 0.1 | Yes | No | | 8.87 | | 18.266 | 3.612 | 0.393 |
| 16% | 0.25 | Yes | No | | 7.333 | | 18.541 | 2.191 | 0.327 |
| 16% | 0.5 | Yes | No | | 6.257 | | 14.105 | 1.54 | 0.324 |
| 16% | 0.75 | No | | | | | | | |
| 16% | 0.9 | No | | | | | | | |
| 20% | 0.0625 | Yes | No | | 7.102 | | 7.459 | 0.561 | 0.435 |
| 20% | 0.1 | Yes | No | | 6.56 | | 13.044 | 0.52 | 0.372 |
| 20% | 0.17 | Yes | No | | 6.173 | | 23.756 | 0.839 | 0.379 |
| 20% | 0.25 | Yes | No | | 6.11 | | | 1.19 | 0.33 |
| 20% | 0.33 | Yes | No | | 6.293 | | 18.51 | 0.384 | 0.369 |

TABLE 6
(Copolymer of (IV) and (V) [3,5py/meta]

| Total | mol | Film | Thermally | | PA/PRU | | Young's | Strain at | |
|---|---|---|---|---|---|---|---|---|---|
| monomer | fraction | forming | stable | Performance | (mole | Conductivity | Modulus | Break | Thickness |
| (weight %) | of (V) | (y/n) | (y/n) | @0.2 A/cm2 | ratio) | @180 C. | (MPa) | (mm/mm) | (mm) |
| 12% | 0.1 | Yes | No | | 11.575 | 0.159 | 10.937 | 1.905 | 0.401 |
| 12% | 0.17 | Yes | No | | 12.549 | 0.194 | 11.156 | 0.512 | 0.39 |
| 12% | 0.25 | Yes | No | | 11.054 | 0.174 | 10.835 | 2.993 | 0.428 |
| 12% | 0.5 | Yes | Yes | 0.59 | 11.923 | 0.175 | 9.194 | 0.148 | 0.371 |
| 12% | 0.67 | No | | | | | | | |
| 16% | 0.1 | Yes | No | | 9.225 | 0.135 | 17.435 | 0.164 | 0.38 |
| 16% | 0.25 | Yes | No | | 8.151 | 0.127 | 16.21 | 0.698 | 0.523 |

TABLE 7
Compliance

| | solid wt % | solid wt % | |
|---|---|---|---|
| | (initial; | (final; | |
| Composition | begin of test) | end of test) | J (20 h) |
| para-PBI | 10.28 | 13.81 | 11.6 |
| para-PBI | 10.76 | 15.95 | 9.1 |
| para-PBI | 11.32 | 14.39 | 10.8 |
| para-PBI | 10.56 | 14.26 | — |
| para-PBI | 11.52 | 14.89 | 10.71 |
| para-PBI | 14.46 | 18.11 | — |
| para-PBI | 14.46 | 18.11 | 5.18 |
| para-PBI | 11.81 | 15.9 | 6.63 |
| para-PBI | 16.75 | 20.38 | 4.08 |
| para-PBI | 16.75 | 18.23 | 4.53 |
| meta/para (5:2) | 27.86 | 34.04 | 2.32 |
| meta/para (5:2) | 27.21 | 34.07 | 2.37 |
| meta/para (4:1) | 27.47 | 34.77 | 2.98 |
| meta/para (4:1) | 27.47 | 35.87 | 2.83 |
| meta/para (7:1) | 28.2 | 33.2 | 2.63 |
| meta/para (7:1) | 27.86 | 32.68 | 2.95 |
| meta-PBI | 24.36 | 32.39 | 2.9 |
| meta-PBI | 24.65 | 29.79 | 2.38 |
| meta-PBI | 26.13 | 32.45 | 2.67 |
| meta-PBI | 25.11 | 31.36 | 3.21 |
| meta-PBI | 34.47 | 42.54 | 2.08 |
| meta-PBI | 32.78 | 43.7 | 1.33 |
| meta-PBI | 18.8 | 25.3 | 3.51 |
| meta-PBI | 20.3 | 23.6 | 5.32 |
| meta-PBI | 20.3 | 24.7 | 5.44 |
| meta-PBI | 26.4 | 33.14 | 2.42 |
| meta-PBI | 27.53 | 33.78 | 2.35 |
| meta-PBI | 27.77 | 36.84 | 2.82 |
| meta-PBI | 29.65 | 36.34 | 3.4 |
| 3.5-pyr/para (3:1) | 38.29 | 44.14 | 3.73 |
| 3.5-pyr/para (3:1) | 39.19 | 45.69 | 3.23 |
| 3.5-pyr/para (1:1) | 34.27 | 43.66 | 3.31 |
| 3.5-pyr/para (1:1) | 38.35 | 45 | 2.97 |
| 3.5-pyr/para (1:5) | 25.7 | 32 | 2.97 |
| 3.5-pyr/para (1:5) | 27.1 | 30.7 | 2.47 |
| 3.5-pyr/para (1:5) | 26.24 | 30.7 | 2.5 |
| 3.5-pyr/2OH (1:1) | 27.07 | 30.7 | 6.09 |
| 3.5-pyr/2OH (1:1) | 26.4 | 32.6 | 2.18 |
| 3.5-pyr/2OH (1:1) | 27.3 | 31.4 | 2.65 |
| 3.5-pyr/2OH (1:1) | 24.91 | 30.68 | 4.32 |
| 2.5-pyr/para (2:1) | 30.81 | 36.28 | 2.27 |
| 2.5-pyr/para (2:1) | 30.11 | 39.5 | 2.1 |
| 2.5-pyr/para (2:1) | 29.6 | 37.1 | 1.95 |
| 2.5-pyr/meta (1:9) | 34.77 | 39.01 | 2.82 |
| 2.5-pyr/meta (1:9) | 35.68 | 40.7 | 2.81 |
| 2.5-pyr/meta (1:9) | 34.82 | 39.78 | 3.03 |
| 2.5-pyr/meta (1:9) | 34.76 | 39.65 | 2.86 |
| 2OH-PBI | 11.1 | 13.45 | 5.78 |
| 2OH-PBI | 11.1 | 14.68 | 5.26 |
| 2.5-pyr | 24.9 | 30.8 | 9.88 |
| 2.5-pyr | 26.88 | 32.73 | 11.3 |

J (20 h) is the compliance after 20 h of creep under compressive stress
The “initial” polymer weight percent is that measured after conditioning the sample in the conditioning rig.
The “final” polymer wt % is after the compression test.

TABLE 8

| | monomer | | | | Phosphoric | | Phosphoric Acid (PA) |
|---|---|---|---|---|---|---|---|
| | charge | I.V.@ | Polymer | | acid | Water | per repeat, unit |
| Composition | (wt %) | 0.2 g/L | (wt %) | | (wt %) | (wt %) | polymer (PBI) (mole) |
| para-PBI | na | na | 5.0 | (8.1) | 56.6 | 38.4 | 35.6 |
| para-PBI | 4 | na | 5.8 | (9.4) | 55.8 | 38.4 | 30 |
| para-PBI | 5 | na | 6.6 | (10.4) | 56.7 | 36.7 | 27 |
| para-PBI | 6 | na | 9.2 | (14.3) | 55.3 | 35.5 | 19 |
| meta/para(5:2) | 7 | 2.78 | 14.0 | (20.5) | 54.4 | 31.6 | 12 |
| meta/para(5:1) | 7 | 2.45 | 14.9 | (21.5) | 54.3 | 30.8 | 12 |
| meta/para(7:1) | 10 | 2.97 | 17.5 | (25.0) | 52.6 | 29.9 | 9.5 |
| meta/para(4:1) | 10 | 3.77 | 17.3 | (20.5) | 51.7 | 31 | 9.4 |
| meta/para(7:1) | 10 | 2.97 | 17.5 | (25.0) | 52.6 | 29.9 | 9.5 |
| meta | 9.1 | 1.61 | 15.7 | (22.8) | 53 | 31.3 | 10.6 |
| meta | 10.74 | 1.62 | 15.7 | (21.3) | 58.2 | 26.1 | 11.6 |
| meta | 7.96 | 1.55 | 20.7 | (29.3) | 50 | 29.3 | 7.6 |
| meta | 10.39 | 1.74 | 8.35 | (11.3) | 65.8 | 25.8 | 24.8 |
| meta | 10.28 | 1.38 | 16.55 | (19.8) | 67.3 | 16.1 | 12.8 |
| meta | 11.96 | 0.66 | 18.0 | (28.0) | 46.2 | 35.8 | 8.07 |
| 3.5-pyr/para (3:1) | 16 | 1.18 | 17.1 | (23.0) | 57.1 | 25.8 | 10.5 |
| 3.5-pyr/para(1:1) | 16 | na | 19.5 | (24.8) | 59.1 | 21.4 | 9.5 |
| 3.5-pyr/para(1:2) | 12 | na | 17.7 | (24.9) | 53.5 | 28.9 | 9.5 |
| 3.5-pyr/para(1:5) | 12 | 1.37 | 14.9 | (21.0) | 56 | 29.1 | 11.8 |
| 3.5-pyr/2OH(1:1) | 12 | 0.6 | 14.6 | (21.8) | 52.4 | 33 | 11.3 |
| 2.5-pyr/para(2:1) | 12 | na | 15.9 | (22.1) | 55.9 | 28.2 | 11.1 |
| 2.5-pyr/meta(1:9) | 12 | 0.94 | 18.9 | (26.4) | 52.7 | 28.4 | 8.8 |
| 2OH-PBI | 3.2 | na | 5.1 | (8.3) | 56.4 | 38.5 | 34.8 |
| 2.5-pyr | 12 | na | 15.2 | (22.5) | 52.5 | 32.3 | 10.9 |

The first number for polymer wt % is the as-prepared polymer wt % (basis polymer+PA+water; first para-PBI example 5.0+56.6+38.4=100%). The figure in parentheses is the polymer wt % without water (basis polymer+PA: first para-PBI example 5.0/(5.0+56.6)=8.1%).

1. A proton-conducting polymer membrane based on polyazole-polymers having
(a) a proton conductivity of the membrane without humidification should be at least 100 mS/cm measured at 160° C.
(b) the Young's Modulus of the membrane should be at least 5 MPa
(c) the compliance J(20h) of the membrane should not more than 6 MPa⁻¹ at 180° C.,
obtainable by a process comprising the steps of
A) mixing:
(i) at least one aromatic tetraamino compounds and
(ii) at least two different aromatic carboxylic acids or esters thereof which contain at least two acid groups per carboxylic acid monomer
or
(iii) at least one aromatic tetraamino compounds and
(iv) one aromatic carboxylic acids or esters thereof which contain at least two acid groups per carboxylic acid monomer,
in polyphosphoric acid to form a solution and/or dispersion
B) heating the mixture from step A and polymerizing until an inherent viscosity of at least 0.8 dl/g is obtained for the copolymer being formed,
C) applying a membrane layer using the mixture according to step B) on a carrier or on an electrode,
D) optionally heating the membrane on the carrier or electrode obtained from step C),
E) treating the membrane formed in the presence of water and/or moisture,
F) removal of the membrane from the carrier,
wherein
G) one of the at least two different aromatic carboxylic acids or esters thereof which contain at least two acid groups per carboxylic acid monomer (first aromatic carboxylic acid) is pyridine-2,5-dicarboxylic acid or pyridine-3,5-dicarboxylic acid, and
H) one of the at least two different aromatic carboxylic acids or esters thereof which contain at least two acid groups per carboxylic acid monomer (second aromatic carboxylic acid) is selected from terephthalic acid, isophthalic acid, di-hydroxy-benzene-1,4-dicarboxylic acid, di-hydroxy-benzene-1,3-dicarboxylic acid, or di-hydroxy-benzene-1,2-dicarboxylic acid,
or
I) one of the at least two different aromatic carboxylic acids or esters thereof which contain at least two acid groups per carboxylic acid monomer (first aromatic carboxylic acid) is terephthalic acid and
J) one of the at least two different aromatic carboxylic acids or esters thereof which contain at least two acid groups per carboxylic acid monomer (second aromatic carboxylic acid) isophthalic acid,
or
K) said one aromatic carboxylic acids monomer being isophthalic acid or an esters thereof,
L) the molar fraction of said first aromatic carboxylic acid is between 0.1 to 0.9 and
M) the molar fraction of said second aromatic carboxylic acid is chosen so that the sum of the molar fraction of the first aromatic carboxylic acid and the molar fraction of the second aromatic carboxylic acid is 1.0,
N) the total amount of all aromatic tetraamino compounds and all aromatic carboxylic acids or esters thereof in step A) is chosen so that the total amount of the copolymers being present is at least 17.5% by weight, and said total amount includes any acids, and water being present, said total content excluding however any optional additives.

2. The membrane as claimed in claim 1, wherein the aromatic tetraamino compounds are 2,3,5,6-tetraaminopyridine, 3,3′,4,4′-tetraaminodiphenylsulfone, 3,3′,4,4′-tetraaminodiphenyl ether, 3,3′,4,4′-tetraaminobiphenyl, 1,2,4,5-tetraaminobenzene, 3,3′,4,4′-tetraaminobenzophenone, 3,3′,4,4′-tetraaminodiphenylmethane or 3,3′,4,4′-tetraaminodiphenyldimethyl-methane and the salts of the aforementioned compounds.

3. The membrane as claimed in claim 1, wherein the aromatic carboxylic acids are
pyridine-2,5-dicarboxylic acid or
pyridine-3,5-dicarboxylic acid,
and
2,3-dihydroxyterephthalic acid,
2,5-dihydroxyterephthalic acid,
2,6-dihydroxyterephthalic acid,
2,4-dihydroxyisophthalic acid,
2,5-dihydroxyisophthalic acid,
2,6-dihydroxyisophthalic acid,
4,5-dihydroxyisophthalic acid,
4,6-dihydroxyisophthalic acid,
3,4-dihydroxyphthalic acid,
3,5-dihydroxyphthalic acid,
3,6-dihydroxyphthalic acid,
4,5-dihydroxyphthalic acid,
4,6-dihydroxyphthalic acid,
2-mono-hydroxyterephthalic acid
2-mono-hydroxyisophthalic acid,
4-mono-hydroxyisophthalic acid,
5-mono-hydroxyisophthalic acid,
3-mono-hydroxyphthalic acid,
4-mono-hydroxyphthalic acid,
5-mono-hydroxyphthalic acid,
6-mono-hydroxyphthalic acid,
isophthalic acid or
terephthalic acid.

4. The membrane as claimed in claim 1, wherein the aromatic carboxylic acids are either alone or in combination with tricarboxylic acids and/or tetracarboxylic acids, their esters, or their anhydrides.

5. The membrane as claimed in claim 4, wherein the aromatic tricarboxylic acid is 1,3,5-benzenetricarboxylic acid (trimesic acid), 1,2,4-benzenetricarboxylic acid (trimellitic acid); (2-carboxyphenyl)iminodiacetic acid, 3,5,3′-biphenyltricarboxylic acid, and/or 3,5,4′-biphenyltricarboxylic acid.

6. The membrane as claimed in claim 4, wherein the aromatic tetracarboxylic acids is 3,5,3′,5′-biphenyltetracarboxylic acid, benzene-1,2,4,5-tetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid and/or 1,4,5,8-naphthalenetetracarboxylic acid.

7. The membrane as claimed in claim 4, wherein the content of tricarboxylic acid or tetracarboxylic acids (based on dicarboxylic acid used) is between 0.1 and 10 mol %.

8. The membrane as claimed in claim 1, wherein the polyphosphoric acid are concentrated grades of phosphoric acid (H₃PO₄) above 100%, but not more than 120%, in which the individual PO₄ units are polymerized and the polyphosphoric acids can be expressed by the formula Hₙ₊₂PₙO₃ₙ₊₁ (n>1).

9. The membrane as claimed in claim 1, wherein the polymer formed in step B) contains (i) repeat units of the general formula (III) or (IV) 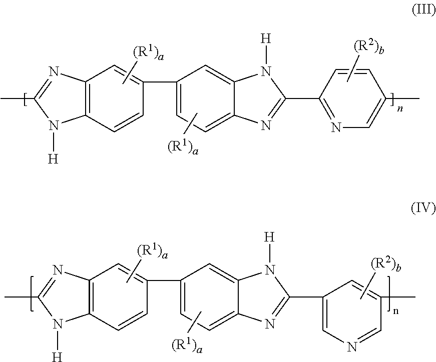
In which
R¹ is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and
R² hydrogen, fluorine an alkyl group having one to ten carbon atoms or an aryl group having 5 to 10 carbon atoms, in said alkyl group or aryl group one or more hydrogen atoms can be replaced by fluorine atoms, and
a is the same or different and is an integer of 0, 1, 2 or 3 and
b is the same or different and is an integer of 0, 1, 2, 3 or 4 and
n is an integer greater than or equal to 10,
and (ii) repeat units of the general formula (I), (II) or (V) 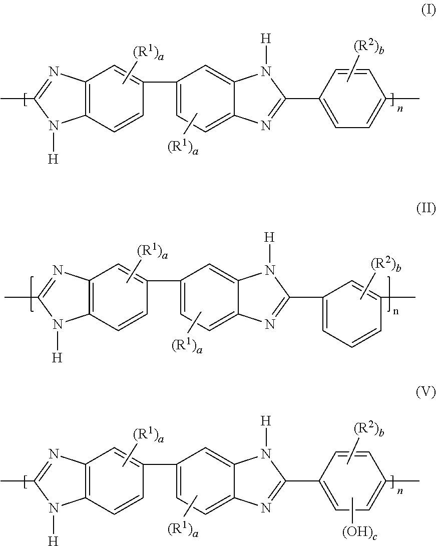
in which
R¹ is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and, and
R² is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and,
a is the same or different and is an integer of 0, 1, 2 or 3 and
b is the same or different and is an integer of 0, 1, 2, 3 or 4 with the proviso that b in formula (V) is an integer of 0, 1, 2 or 3 and the total of b and c is not more than 4,
c is the same or different and is an integer of 1 or 2, preferably 2, and
n is an integer greater than or equal to 10, preferably greater than or equal to 100, or is a homopolymer of the general formula (II) 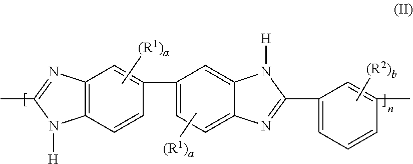
in which
R₁ is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and, and
R² is the same or different and is hydrogen, fluorine an alkyl group having one to ten carbon atoms or an aryl group having 5 to 10 carbon atoms, in said alkyl group or aryl group one or more hydrogen atoms can be replaced by fluorine atoms, and,
a is the same or different and is an integer of 0, 1, 2 or 3 and
b is the same or different and is an integer of 0, 1, 2, 3 or 4 and
n is an integer greater than or equal to 10.

10. The membrane as claimed in claim 1, wherein the polymer formed in step B) is a random copolymer or a homopolymer.

11. The membrane as claimed in claim 1, wherein the polymer formed in step B) contains (i) repeat units of the general formula (III) or (IV) and (ii) at least one repeat units of the general formula (I), (II) or (V) or is a homopolymer having repeat units of the general formula (II).

12. The membrane as claimed in claim 1, wherein for the copolymer formed in step B) which contains repeat units of the general formula (III) [2,5py] and repeat units of the general formula (II) [m-PBI] the molar fraction of the repeat units of the general formula (II) is between 0.1 to 0.9 for a total monomer load (total amount of all aromatic tetraamino compounds and all aromatic carboxylic acids or esters thereof in step A) from 8% to 22% by weight and from 0.5 to 0.9 for a total monomer load (total amount of all aromatic tetraamino compounds and all aromatic carboxylic acids or esters thereof in step A) from 12% to 18% by weight.

13. The membrane as claimed in claim 1, wherein for the copolymer formed in step B) which contains repeat units of the general formula (III) [2,5py] and repeat units of the general formula (I) [p-PBI] the molar fraction of the repeat units of the general formula (I) is between 0.02 to 0.5 for a total monomer load (total amount of all aromatic tetraamino compounds and all aromatic carboxylic acids or esters thereof in step A) of at least 10% by weight, and for a total monomer load (total amount of all aromatic tetraamino compounds and all aromatic carboxylic acids or esters thereof in step A) from 10 to 12% by weight and from 0.04 to 0.25 for a total monomer load (total amount of all aromatic tetraamino compounds and all aromatic carboxylic acids or esters thereof in step A) from more than 10% to 16% by weight.

14. The membrane as claimed in claim 1, wherein for the copolymer formed in step B) which contains repeat units of the general formula (III) [2,5py] and repeat units of the general formula (V) [2OH-PBI] the molar fraction of the repeat units of the general formula (V) is between 0.1 to 0.4, and for a total monomer load (total amount of all aromatic tetraamino compounds and all aromatic carboxylic acids or esters thereof in step A) from 8 to 12% by weight.

15. The membrane as claimed in claim 1, wherein for the copolymer formed in step B) which contains repeat units of the general formula (IV) [3,5py] and repeat units of the general formula (I) [p-PBI] the molar fraction of the repeat units of the general formula (I) is between 0.3 to 0.85 and for a total monomer load (total amount of all aromatic tetraamino compounds and all aromatic carboxylic acids or esters thereof in step A) of at least 8% by weight and for a total monomer load (total amount of all aromatic tetraamino compounds and all aromatic carboxylic acids or esters thereof in step A) from 8 to 12% by weight and from 0.3 to 0.5 for a total monomer load (total amount of all aromatic tetraamino compounds and all aromatic carboxylic acids or esters thereof in step A) from more than 12% to 16% by weight, and from 0.25 to 0.35 for a total monomer load (total amount of all aromatic tetraamino compounds and all aromatic carboxylic acids or esters thereof in step A) from more than 16% to 20% by weight.

16. The membrane as claimed in claim 1, wherein for the copolymer formed in step B) which contains repeat units of the general formula (IV) [3,5py] and repeat units of the general formula (II) [m-PBI] the molar fraction of the repeat units of the general formula (II) is between 0.05 to 0.9 and for a total monomer load (total amount of all aromatic tetraamino compounds and all aromatic carboxylic acids or esters thereof in step A) from 10 to 20% by weight and from 0.5 to 0.9 for a total monomer load (total amount of all aromatic tetraamino compounds and all aromatic carboxylic acids or esters thereof in step A) from more than 12% to 16% by weight, and from 0.05 to 0.4 for a total monomer load (total amount of all aromatic tetraamino compounds and all aromatic carboxylic acids or esters thereof in step A) from more than 16% to 20% by weight.

17. The membrane as claimed in claim 1, wherein for the copolymer formed in step B) which contains repeat units of the general formula (IV) [3,5py] and repeat units of the general formula (V) [2OH-PBI] the molar fraction of the repeat units of the general formula (V) is 0.5+/−20% for a total monomer load (total amount of all aromatic tetraamino compounds and all aromatic carboxylic acids or esters thereof in step A) of 12% (+/−5%) by weight.

18. The membrane as claimed in claim 1, wherein the membrane obtained in step C) or D) is treated in the presence of moisture at temperatures and for a period until the membrane is self-supporting and can be removed from the carrier without damage.

19. The membrane as claimed in claim 1, wherein the treatment in step E) is performed at temperatures above 0° C. and 150° C. in the presence of moisture or water or liquids containing water and/or steam.

20. The membrane as claimed in claim 1, wherein the treatment of the membrane in step E) is between 10 seconds and 300 hours.

21. The membrane as claimed in claim 1, wherein the carrier selected in step C) is an electrode and the treatment in step E) is such that the membrane formed is no longer self-supporting.

22. The membrane as claimed in claim 1, wherein a membrane having a thickness of 20 and 4000 μm is obtained in step C).

23. The membrane as claimed in claim 1, wherein the membrane formed by step E) has a thickness between 15 and 3000 μm.

24. The membrane as claimed in claim 1, wherein the membranes have a Young's modulus of at least 5.0 MPa.

25. The membrane as claimed in claim 1, characterized in that the membranes have a compliance J(20h) of not more than 6 MPa⁻¹ at 180° C. and a total amount of copolymers being present which is at least 17.5% by weight and said total amount includes any acids, and water being present, said total content excluding however any optional additives.

26. The membrane as claimed in claim 1, wherein the membrane has a proton conductivity of the membrane without humidification of at least 100 mS/cm at 180° C.

27. An electrode which having a proton-conducting polymer coating based on polyazoles, obtainable by a process comprising the steps of
A) mixing:
(i) at least one aromatic tetraamino compounds and
(ii) at least two different aromatic carboxylic acids or esters thereof which contain at least two acid groups per carboxylic acid monomer,
or
(iii) at least one aromatic tetraamino compounds and
(iv) one aromatic carboxylic acids or esters thereof which contain at least two acid groups per carboxylic acid monomer,
in polyphosphoric acid to form a solution and/or dispersion
B) heating the mixture from step A), preferably under inert gas, and polymerizing until an inherent viscosity of at least 0.8 dl/g is obtained for the copolymer being formed,
C) applying a membrane layer using the mixture according to step B) on an electrode,
D) optionally heating the membrane on the electrode obtained from step C),
E) treating the membrane formed in the presence of water and/or moisture,
wherein
F) one of the at least two different aromatic carboxylic acids or esters thereof which contain at least two acid groups per carboxylic acid monomer (first aromatic carboxylic acid) is pyridine-2,5-dicarboxylic acid or pyridine-3,5-dicarboxylic acid, and
G) one of the at least two different aromatic carboxylic acids or esters thereof which contain at least two acid groups per carboxylic acid monomer (second aromatic carboxylic acid) is selected from terephthalic acid, isophthalic acid, di-hydroxy-benzene-1,4-dicarboxylic acid, di-hydroxy-benzene-1,3-dicarboxylic acid, or di-hydroxy-benzene-1,2-dicarboxylic acid,
or
H) one of the at least two different aromatic carboxylic acids or esters thereof which contain at least two acid groups per carboxylic acid monomer (first aromatic carboxylic acid) is terephthalic acid and
I) one of the at least two different aromatic carboxylic acids or esters thereof which contain at least two acid groups per carboxylic acid monomer (second aromatic carboxylic acid) isophthalic acid,
or
J) said one aromatic carboxylic acids monomer being isophthalic acid or an esters thereof,
K) the molar fraction of said first aromatic carboxylic acid in F) or H) is between 0.1 to 0.9 and
L) the molar fraction of said second aromatic carboxylic acid is chosen so that the sum of the molar fraction of the first aromatic carboxylic acid and the molar fraction of the second aromatic carboxylic acid is 1.0,
M) the total amount of all aromatic tetraamino compounds and all aromatic carboxylic acids or esters thereof in step A) is chosen so that the total amount of the copolymers being present is at least 17.5% by weight, and said total amount includes any acids, and water being present, said total content excluding however any optional additives.

28. The electrode as claimed in claim 27, the membrane after Step E) having a thickness between 2 and 3000 μm.

29. A membrane-electrode unit comprising at least two electrodes and at least one membrane as claimed in claim 1.

30. A membrane-electrode unit comprising at least one electrode as claimed in claim 27.

31. A fuel cell comprising one or more membrane-electrode units as claimed in claim 29.
